(19) United States
(12) Patent Application Publication
(10) Pub. No.: US 2026/0071636 A1
(43) Pub. Date: Mar. 12, 2026

(54) VACUUM PUMP WITH AN EDDY CURRENT DAMPER

(71) Applicant: Leybold GmbH, Cologne (DE)

(72) Inventors: Christian Hoesgen, Cologne (DE); Dirk Christian Kalisch, Cologne (DE); Alois Greven, Cologne (DE); Daniel Radermacher, Cologne (DE); Christian Berger, Cologne (DE); Roman Dembek, Cologne (DE)

(21) Appl. No.: 19/101,795

(22) PCT Filed: Aug. 7, 2023
(86) PCT No.: PCT/EP2023/071854

§ 371 Date: Feb. 6, 2025

(30) Foreign Application Priority Data
Aug. 9, 2022 (GB) 2211565.3

(51) Int. Cl. F04D 29/66; F04D 19/04; F04D 29/058; F16F 15/03

(52) U.S. Cl. CPC F04D 29/668; F04D 19/042; F04D 19/048; F04D 29/058; F16F 15/035; F16F 2222/06

(57) ABSTRACT

Vacuum pump, in particular a turbomolecular vacuum pump, comprising a housing and a rotor shaft disposed in the housing and rotatably supported by at least on permanent magnet bearing. Therein, the magnet bearing is arranged at one end of the rotor shaft and wherein the magnet bearing comprises a static bearing element and a rotated bearing element radially arranged next to each other. An eddy current damper is provided having a conductive disk connected to the static bearing element.

### CROSS-REFERENCE OF RELATED APPLICATION

This application is a Section 371 National Stage Application of International Application No. PCT/EP2023/071854, filed Aug. 7, 2023, which is incorporated by reference in its entirety and published as WO 2024/033323 A1 on Feb. 15, 2024, the content of which is hereby incorporated by reference in its entirety and which claims priority of British Application No. GB2211565.3, filed Aug. 9, 2022.

### FIELD

The present invention relates to a vacuum pump and in particular to a turbomolecular pump.

### BACKGROUND

Common vacuum pumps comprise a housing having an inlet and an outlet. A rotor is disposed in the housing and rotatably supported by at least one bearing. The rotor comprises a rotor shaft, wherein at least one pump element is connected to the rotor shaft. In the case of a turbomolecular vacuum pump a plurality of vanes is connected to the rotor shaft and interacting with a plurality of vanes of a stator being connected to a housing. Upon rotation of the rotor by an electromotor a gaseous medium is conveyed from the inlet towards the outlet of the vacuum pump.

In particular, if the rotor shaft is rotatably supported by one or more magnetic bearings the radial vibrations of the rotor shaft need to be damped in order to stabilize rotation of the rotor shaft and avoid contact between the pump elements and the housing. However, such a damper is an additional element which need to be considered and usually increases the size of the vacuum pump.

The discussion above is merely provided for general background information and is not intended to be used as an aid in determining the scope of the claimed subject matter. The claimed subject matter is not limited to implementations that solve any or all disadvantages noted in the background.

### SUMMARY

The problem is solved by a vacuum pump according to claim 1 and a vacuum pump according to claim 8.

In a first aspect a vacuum pump is provided preferably built as turbomolecular pump. The vacuum pump comprises a housing and a rotor shaft disposed in the housing and rotatably supported by at least one magnet bearing built as permanent magnet bearing. Therein, at least one pump element is connected to the rotor shaft and upon rotation of the rotor shaft by an electromotor a gaseous medium is conveyed from an inlet of the vacuum pump towards an outlet of the vacuum pump. Therein, the magnet bearing is arranged at one end of the rotor shaft and the magnet bearing comprises a static bearing element connected to the housing of the vacuum pump and not rotating. Further, the magnet bearing comprises a rotated bearing element radial connected to the rotor shaft and rotated relative to the static bearing element. The rotated bearing element is arranged next to the static bearing elements in order to support the rotor shaft by a mutual magnetic repulsion between the static bearing element and the rotated bearing element.

According to the present invention an eddy current damper (ECD) is provided having a conductive disk being connected to the static bearing element. Thus, by the present invention the eddy current damper for damping radial vibrations of the rotor shaft is integrated into the magnetic bearing thereby reducing the space requirements. Further, since the magnetic bearing is arranged at one end of the rotor shaft, radial vibration of the rotor shaft by tilting or nutation of the rotor shaft is largest at the end of the rotor shaft. Thereby, damping this movement at the ends of the rotor shaft is most efficient. Thus, the ECD can be built small but still maintain its damping efficiency.

Preferably, the static bearing element is connected to a trunnion extending into a recess of the rotor shaft.

Preferably, the static bearing element and the rotated bearing element which comprises a plurality of ring magnets in mutual repulsion to each other. Thus, by the ring magnets of the static bearing element and the rotated bearing element the repulsive magnetic force between them is created.

Preferably, the magnetic bearing comprises an adjustment element connected to the static bearing element to adjust the axial position of the static bearing element relative to the rotated bearing element wherein the conductive disk is attached to the adjustment element. Thus, by inserting the adjustment element into the magnetic bearing upon assembly, at the same time the ECD including the conductive disk is assembled.

Preferably, the adjustment element is made from a ferritic material. Thus, the magnetic field of the static bearing element permeates the ferritic adjustment element in order to create a magnetic circuit and enhancing the magnetic field at the position of the conductive disk.

Preferably, the static bearing element comprises a radial protrusion wherein the conductive disk is connected to the radial protrusion. Thus, by the radial protrusion the conductive disk can be placed axially next to the respective ring magnets of the ECD being connected to the rotated bearing element in order to induce the eddy currents into the conductive disk. Therein, more preferably the radial protrusion can be built by an extra element arranged between the axial outermost ring magnet of the static bearing element and the adjustment element, or can be built as one piece with the adjustment element for ease of assembly.

Preferably, the conductive disk is arranged axially next to the rotated bearing element such that by the magnetic field of the rotated bearing element eddy currents can be induced into the conductive disk.

Preferably, the outmost ring magnet of the rotated bearing element is at the same time the magnet ring of the ECD such that the magnetic field of the outmost ring element of the rotated bearing element induces eddy currents into the conductive disk. No additional ring magnet for the ECD need to be implemented and the magnetic field of the rotated bearing element can be used for the ECD as well. Alternatively, the ECD comprises an additional ring magnet connected to the rotated bearing element and separated from the ring magnets of the rotated bearing element by a non-magnetic material. Thereby a magnetic circuit is created by the additional ring magnet across the gap between the rotated bearing element and the adjustment element preferably made from a ferritic material.

Preferably, the ECD is arranged at an axial end of the rotor shaft, i.e. between the magnetic bearing and the end of the rotor shaft in order to position the ECD at the outmost position of the rotor shaft to efficiently damper radial vibrations of the rotor shaft.

Preferably, the eddy current damper is arranged at the exhaust side of the rotor shaft. Alternatively, the ECD is arranged at the inlet side or high vacuum side of the rotor shaft. More preferably, at both ends of the rotor shaft an ECD is arranged. Therein, the ECD of both ends can be built similar or different and in particular built as described before.

Thus, a compact design of the eddy current damper is provided being integrated into the magnetic bearing of the vacuum pump. Therein, at the same time, the ECD is placed at a position at which the rotor shaft is subject to the largest vibration due to tilting around the center of gravitation of the rotor shaft.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

In the following the present invention is described with reference to the accompanied figures.

### The Figures Show:

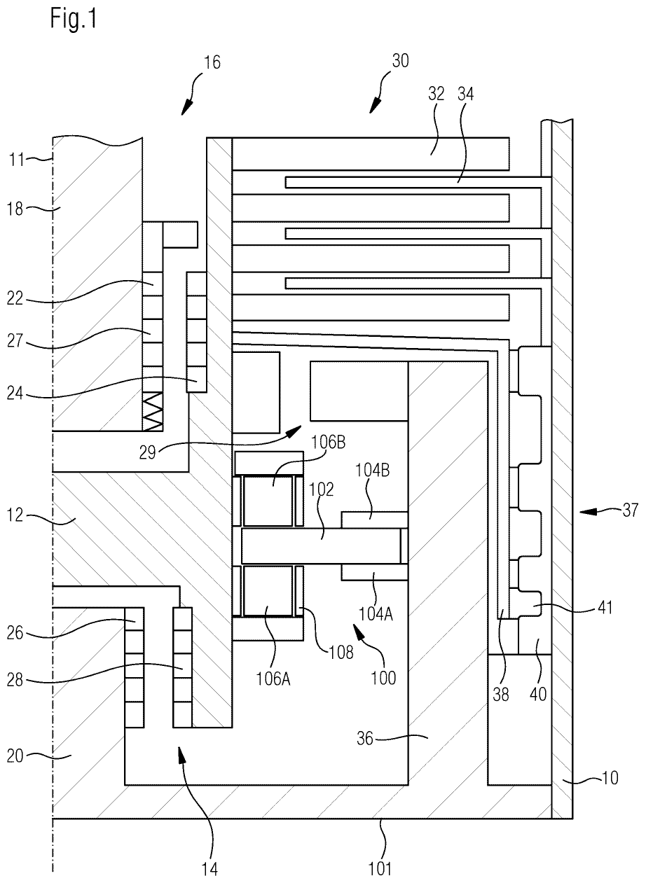

FIG. 1 a first embodiment according to the present invention,

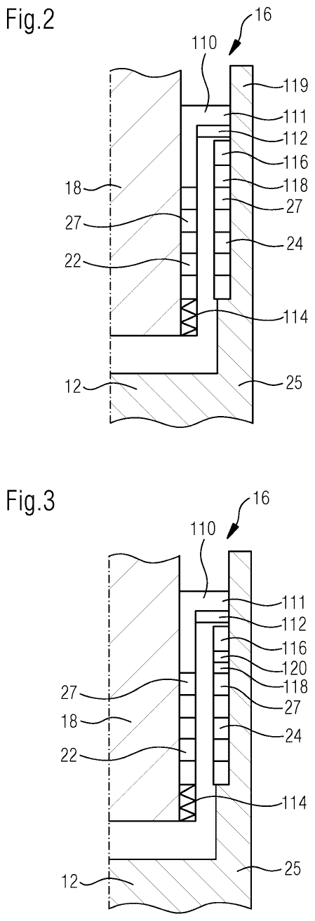

FIG. 2 a detailed view of the second embodiment of the present invention,

FIG. 3 a detailed view of another embodiment of the present invention and

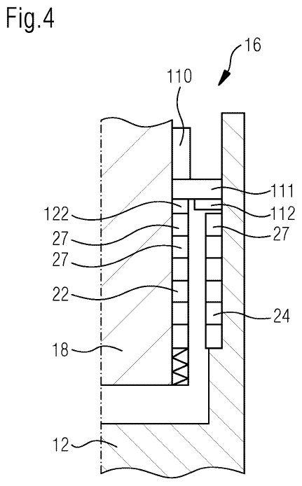

FIG. 4 a detailed view of another embodiment of the present invention.

### DETAILED DESCRIPTION

Referring to FIG. 1 showing a vacuum pump built as molecular vacuum pump. Therein, for simplicity only one half of the vacuum pump is shown being substantially symmetrical around the center excess 11. The vacuum pump comprises a housing 10 wherein in the housing a rotor shaft 12 is disposed. The rotor shaft 12 is rotatably supported by a first bearing 16 built as permanent magnetic bearing and a second bearing 14 also built as permanent magnetic bearing. The first magnetic bearing 16 comprises a static bearing element 22 connected to the housing via a trunnion 18 extending into recess of the rotor shaft 12. Further, the first magnetic bearing 16 comprises a rotated bearing element 24 connected to the rotor shaft 12. The static bearing element 22 and the rotated bearing element 24 comprise each a number of ring magnets 27 being in mutual repulses to each other in order to create radial support between the static bearing element 22 and the rotated bearing element 24. Similar, the second magnetic bearing 14 also comprises a static bearing element 26 comprises a plurality of ring magnets 27 and a rotated bearing element 28 being connected to the rotor shaft 12 also comprising a plurality of ring magnets 27 being in mutual repulsing to the ring magnets 27 of the static bearing element 26. Therein, as shown in FIG. 1, the static bearing element is also connected to the housing 10 via a trunnion 20.

The rotor shaft 12 is rotated by an electromotor 29. A plurality of pump elements 32 built as vanes are connected to the rotor shaft 12 and interacting with stator elements 34 alternating arranged to the pump elements 32 and interacting with each other in order to convey a gaseous medium. Further, the vacuum pump comprises a Holweck stage 37 including a cylinder 38 being connected to the rotor shaft and rotated together with the rotor shaft. Further, the Holweck stage 37 comprises a Holweck stator 40 having a threaded groove 41 in order to convey the gaseous medium from the inlet 30 towards an outlet of the vacuum pump (not shown). Therein, the housing 10 comprises an interior wall 36 wherein the stator of the electromotor 29 is connected to the interior wall. The interior wall 36 is extending into the inner volume of the cylinder 38 of the Holweck stage 37.

Further, according to the present invention the vacuum pump comprises an eddy current damper 100 (ECD). The ECD is arranged inside the cylinder 38 of the Holweck stage 37 in order to provide a compact design of the vacuum pump.

The ECD comprises a disk 102 made of a conductive material such as copper or aluminum. The disk 102 is connected via connecting elements 104A and 104B to the interior wall 36 of the housing 10. Thus, the disk 102 is non-rotating. Further, the ECD 100 comprises a first ring magnet 106A and a second ring magnet 106B being arranged axially next to the disk 102. By the first ring magnet 106A and the second ring magnet 106B a gap is created, wherein the conductive disk 102 of the ECD 100 extends into the gap. First ring magnet 106A and second ring magnet 106B are attached to the rotor shaft 12 and rotated together with the rotor shaft 12. Thus, due to rotation and upon radial vibrations of the rotor shaft 12, by the magnetic field at the position of the conductive disk 102 eddy currents are induced into the conductive disk 102 wherein the induced eddy currents create a magnetic field interacting with the magnetic field of the first ring magnet 106A and second ring magnet 106B wherein the created magnetic force is opposite to the movement of vibration thereby creating a restoring force to the rotor shaft 12 and damping the radial vibration of the rotor.

Therein, the conductive disk 102 can be separated into two parts along its circumferential direction. Thus, the first ring magnet 106A and second ring magnet 106B can be preassembled to the rotor shaft 12. Afterwards the conductive disk 102 is assembled around the rotor shaft 12. Subsequently, the rotor shaft 12 is inserted into the housing 10 and attached by the connecting elements 104A, 104B to the interior wall 36 of the cap element 101 of the housing 10. Alternatively, the rotor shaft 12 is inserted into a first housing element, subsequently, the conductive disk 102 is assembled around the rotor shaft 12 and afterwards the cap element 101 with the interior wall 36 is inserted into the housing, i.e. into the cylinder of the rotor. In a last step, the conductive disk 102 is connected to the interior wall 36.

Thus, by the embodiment of FIG. 1 a compact design for vacuum pump is provided wherein the space within the cylinder 38 of the Holweck stage 37 is efficiently used in order to place an ECD to damper radial vibrations of the rotor.

Referring to FIG. 2 showing a detailed view of the first magnet bearing 16 at the inlet side of the of a vacuum pump which can be built similar than the vacuum pump of FIG. 1.

In the following same or similar elements are indicated by the same reference sings.

In FIG. 2 the static bearing element 22 comprises an adjustment element 110 in order to adjust the axial position of the static bearing element 22 by adjusting the position of the static bearing element 22 against the restoring force of the spring 114. Therein, the adjustment element 110 comprises a radial protrusion 111 wherein a conductive disk 112 is connected to the radial protrusion 111. Thus, by the radial protrusion 111 the conductive disk 112 is arranged axially next to a ring magnet 116 of the ECD connected to the rotor shaft 12. The ring magnet 116 of the ECD is separated by a non-magnetic ring element 118 from the ring magnets 27 of the rotated bearing element 24. Thus, by this configuration, the ECD is integrated into the magnetic bearing providing a compact design. In particular, the ECD is positioned between the magnetic bearing and the end 119 of the rotor shaft 12. Thus, efficient damping of radial vibrations can be achieved. Further, due to its position, the ECD can be built small while still efficiently damping the radial vibrations.

Alternatively, the ECD of FIG. 2 can also be implemented in the second magnetic bearing at the exhaust side of the vacuum pump.

Referring to FIG. 3 showing a similar configuration to FIG. 2 wherein a ferritic material element 120 is placed between the ring magnet 116 of the ECD and the non-magnetic material element 118 separating the ring magnet 116 of the ECD from the ring magnets 27 of the rotated bearing element 24. Thus, by the ferritic material element 120 a magnetic circuit is created enhancing the magnetic field at the position of the conductive disk 112. In particular, the adjustment element 110 is also built from a ferritic material further enhancing the magnetic field at the position of the conductive disk 116 by creating a full or almost closed magnetic circuit.

Although shown in FIG. 3 that the ECD is implemented in the first magnetic bearing at the inlet side of the vacuum pump, the ECD can also be implemented, alternatively or additionally, in the second magnetic bearing at the exhaust side of the vacuum pump.

Referring to FIG. 4 showing another embodiment of the present invention wherein the adjustment 110 includes a radial protrusion 111 as separate element carrying the conductive disk 112. Therein, the conductive disk 112 is axially next to the outermost ring magnet 27 of the rotated bearing element 24. Thus, the outermost ring magnet 27 of the rotated bearing element 24 simultaneously facilitates supporting the rotor shaft 12 and at the same time is used as ring magnet for the ECD inducing eddy currents upon vibration of the rotor shaft. Thereby, a compact design is achieved and an additional ring magnet only for the ECD can be avoided.

Although shown in FIG. 4 that the ECD is implemented in the first magnetic bearing at the inlet side of the vacuum pump, the ECD can also be implemented, alternatively or additionally, in the second magnetic bearing at the exhaust side of the vacuum pump.

Of course, the embodiments of FIG. 1 and FIG. 2 to 4 can be freely combined. The vacuum pump may comprise an eddy current damper placed within the cylinder 38 of the Holweck stage 37 in connection with an additional eddy current damper integrated in one of the magnetic bearings 14, 16. Furthermore the vacuum pump may comprise an ECD integrated in the first magnetic bearing 16 or in the second magnetic bearing 14. Alternatively, the vacuum pump comprises an ECD in the first magnetic bearing as well as in the second magnetic bearing. Therein, the ECDs can be built identically along with one of the embodiments 2 to 4 or can be built different according to one of the embodiments of FIGS. 2 to 4.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A vacuum pump, in particular a turbomolecular vacuum pump, comprising a housing;
a rotor shaft disposed in the housing and rotatably supported by at least on permanent magnet bearing;
wherein the magnet bearing is arranged at one end of the rotor shaft and
wherein the magnet bearing comprises a static bearing element and a rotated bearing element radially arranged next to each other and an eddy current damper having a conductive disk connected to the static bearing element.

2. The vacuum pump according to claim 1, wherein the static bearing element and the rotated bearing element each comprises a plurality of ring magnets in mutual repulsion to each other.

3. The vacuum pump according to claim 1, wherein the magnetic bearing comprises an adjustment element connected to the static bearing element to adjust the axial position of the static bearing element relative to the rotated bearing element, wherein the conductive disk is attached to the adjustment element.

4. The vacuum pump according to claim 3, wherein the adjustment element is made from a ferritic material.

5. The vacuum pump according to claim 1, wherein the static bearing element comprises a radial protrusion, wherein the conductive disk is connected to the radial protrusion.

6. The vacuum pump according to claim 5, wherein the conductive disk is arranged axially next to the rotated bearing element such that by the magnetic field of the rotated bearing element eddy currents can be induced into the conductive disk.

7. The vacuum pump according to claim 1, wherein the eddy current damper comprises a ring magnet connected to the rotated bearing element and separated from the ring magnets of the rotated bearing element by a non-magnetic material.

8. The vacuum pump according to claim 1, wherein the eddy current damper is arranged at the axial end of the rotor shaft.

9. The vacuum pump according to claim 1, wherein the eddy current damper is arranged at the exhaust side of the rotor shaft.

10. The vacuum pump according to claim 1, wherein at both ends of the rotor shaft each an eddy current damper is arranged.
